(19) United States
(12) Patent Application Publication
(10) Pub. No.: US 2005/0182903 A1
(43) Pub. Date: Aug. 18, 2005

(54) Apparatus and method for preventing duplicate matching entries in a translation lookaside buffer

(75) Inventors: Ryan C. Kinter, Los Altos, CA (US); G. Michael Uhler, Menlo Park, CA (US)

Correspondence Address: HUFFMAN LAW GROUP, P.C., 1832 N. CASCADE AVE., COLORADO SPRINGS, CO, 80907-7449, US

(73) Assignee: MIPS Technologies, Inc., Mountain View, CA (US)

(21) Appl. No.: 10/777,714

(22) Filed: Feb. 12, 2004

(51) Int. Cl. G06F 12/08

(52) U.S. Cl. 711/133; 711/207; 711/144

(57) ABSTRACT

A method and apparatus for preventing duplicate matching entries in a TLB is disclosed. Each entry in the TLB has an Include bit that specifies whether to include or exclude the entry in tag match determinations. When a TLB write is attempted, if the write tag matches a tag in an entry of the TLB, the entry's Include bit is cleared so that the entry is excluded in subsequent match determinations. Furthermore, if the matching entry is an entry other then the entry to be written, and the matching entry is valid, and the value to be written to the entry is valid, then an exception is generated and the write is aborted. When an entry is successfully written, its Include bit is set so that the entry is included in subsequent match determinations. The Include bit is also used to qualify tag lookup match determinations.

### FIELD OF THE INVENTION

This invention relates in general to the field of translation lookaside buffers in microprocessors and particularly to preventing duplicate matching entries therein.

### BACKGROUND OF THE INVENTION

Many modern microprocessors support the notion of virtual memory. In a virtual memory system, instructions of a program executing on the microprocessor refer to data using virtual addresses in a virtual address space of the microprocessor. Additionally, the instructions themselves are referred to using virtual addresses in the virtual address space. The virtual address space may be much larger than the actual physical memory space of the system, and in particular, the amount of virtual memory is typically much greater than the amount of physical memory present in the system. The virtual addresses generated by the microprocessor are translated into physical addresses that are provided on a processor bus coupled to the microprocessor in order to access system memory or other devices, such as I/O devices.

A common virtual memory scheme supported by microprocessors is a paged memory system. A paged memory system employs a paging mechanism for translating, or mapping, virtual addresses to physical addresses. The physical address space is divided up into physical pages of fixed size. A common page size is 4 KB. The virtual addresses comprise a virtual page address portion and a page offset portion. The virtual page address specifies a virtual page in the virtual address space. The virtual page address is translated by the paging mechanism into a physical page address. The page offset specifies a physical offset in the physical page, i.e., a physical offset from the physical page address.

The advantages of memory paging are well known. One example of a benefit of memory paging systems is that they enable programs to execute with a larger virtual memory space than the existing physical memory space. Another benefit is that memory paging facilitates relocation of programs in different physical memory locations during different or multiple executions of the program. Another benefit of memory paging is that it allows multiple processes to execute on the processor simultaneously, each having its own allocated physical memory pages to access without having to be swapped in from disk, and without having to dedicate the full physical memory to one process. Another benefit is that memory paging facilitates memory protection from other processes on a page basis.

Page translation, i.e., translation of the virtual page address to the physical page address, is accomplished by what is commonly referred to as a page table walk. Typically, the operating system maintains page tables that contain information for translating the virtual page address to a physical page address. Typically, the page tables reside in system memory. Hence, it is a relatively costly operation to perform a page table walk, since multiple memory accesses must typically be performed to do the translation.

To improve performance by reducing the number of page table walks, many microprocessors provide a mechanism for caching page table information, which includes physical page addresses translated from frequently used virtual page addresses. The page table information cache is commonly referred to as a translation lookaside buffer (TLB). The virtual page address is provided to the TLB, and the TLB performs a lookup of the virtual page address. If the virtual page address hits in the TLB, then the TLB provides the corresponding translated physical page address, thereby avoiding the need to perform a page table walk to translate the virtual page address to the physical page address.

Some microprocessors that employ a TLB automatically fill the contents of the TLB as needed. However, other microprocessors rely upon the operating system to program the contents of the TLB. In a microprocessor of the latter type, the possibility exists for the operating system to have programmed the TLB with two different entries that both have a virtual page address that matches the virtual page address that the TLB is asked to translate, i.e., to lookup. This is an undesirable situation. First, it is unclear which, if either, of the two translated physical page addresses the TLB should output. If the TLB outputs the wrong physical page address, data will potentially be corrupted if the processor is allowed to continue operating without remedying the situation. Second, depending upon the implementation of the TLB circuitry, attempting to output more than one physical address may result in damage to the microprocessor integrated circuit.

Therefore, what is needed is an apparatus and method for preventing multiple matching entries in a TLB.

### SUMMARY

In one aspect, the present invention provides a TLB that includes an indicator in each entry. The indicator specifies whether the entry should be included or excluded when the TLB determines whether a virtual address matches any entries in the TLB. When an entry in the TLB is successfully written, the indicator is set in the entry written. When software attempts to write an entry in the TLB and the virtual address to be written matches the virtual address of an existing TLB entry, then the indicator of the matching entry is cleared, thereby causing the matching entry to be excluded from match determinations until the entry is successfully written. In addition, the write to the TLB is aborted, and an exception is generated to inform the operating system that a write of a duplicate matching entry was attempted and to allow the operating system to remedy the situation. However, the write is aborted and the exception generated only if the matching entry was an entry other than the entry to be written, the matching entry is valid, and the value being written into the entry is valid. Otherwise, the TLB writes the specified entry. By so doing, the number of exceptions generated is advantageously reduced.

Other features and advantages of the present invention will become apparent upon study of the remaining portions of the specification and drawings.

### BRIEF DESCRIPTION OF THE DRAWINGS

FIG. 1 is a block diagram of a microprocessor core according to the present invention.

FIG. 2 is a block diagram of the TLB of FIG. 1 according to the present invention.

FIG. 3 is a block diagram of the data array of FIG. 2 according to the present invention.

FIG. 4 is a block diagram of the tag array block of FIG. 2 according to the present invention.

FIG. 5 is a block diagram illustrating the exception generation logic of FIG. 2 according to the present invention.

FIG. 6 is a flowchart illustrating operation of the microprocessor during a write operation to the TLB of FIG. 1 according to the present invention.

FIG. 7 is a flowchart illustrating operation of the microprocessor during a lookup operation of the TLB of FIG. 1 according to the present invention.

FIG. 8 is a block diagram illustrating a processing system employing the microprocessor and translation lookaside buffer of FIG. 1 according to the present invention.

### DETAILED DESCRIPTION

In order to more fully appreciate the advantages of the present invention it is useful to first discuss scenarios in which software, such as an operating system, may attempt to write a duplicate matching entry into a TLB.

A first scenario involves the transfer of control to the operating system from firmware, such as a ROM monitor on a circuit board incorporating the microprocessor with the TLB. When the computer system is reset, the firmware initializes the TLB to a known state by writing each entry of the TLB, such as with a translated physical page address equal to the virtual page address. Each firmware write of the TLB necessarily specifies a virtual page address somewhere within the virtual address space of the processor that is written into the entry. When control is transferred to the operating system, the operating system begins to write entries into the TLB, perhaps itself to initialize the TLB to a known state. The operating system does not know which virtual page addresses have been written into the TLB by the firmware. Hence, a possibility exists that the operating system will attempt to write an entry of the TLB with the same virtual page address as another entry of the TLB that was written by the firmware.

A second scenario involves the operating system flushing the TLB. An example of a situation in which the operating system flushes the TLB is in response to a task switch. The operating system flushes the TLB by invalidating each entry of the TLB. That is, the operating system writes each entry with a valid bit value indicating the entry does not contain a valid virtual to physical page address translation. Because each invalidating write necessarily specifies a virtual page address somewhere within the virtual address space of the processor, the possibility exists that the operating system will attempt to write a duplicate matching entry in the TLB for the virtual page address. In theory, the operating system could take measures to examine the current contents of the TLB and insure that it did not write the TLB with a duplicate matching entry. However, in practice, the operating system simply wants to flush the TLB as quickly as possible by invalidating each entry without regard for the current virtual page addresses stored in the TLB. Hence, the flush routine commonly writes each entry of the TLB with the same virtual page address with an invalid value in the valid bit. The TLB flush routine would be much more involved and take longer if it flushed the TLB based on the current contents of the TLB to avoid writing duplicate entries.

A third scenario involves the operating system writing new entries into the TLB after flushing the TLB. Because the operating system's TLB flush routine had to select some virtual page address to write into the TLB entries to invalidate them, the possibility exists that a virtual page now allocated by the operating system to a new task has the same virtual page address as the virtual page address selected by the TLB flush routine. Hence, when the operating system TLB refill routine writes the new valid entry into the TLB, a duplicate matching write may be attempted.

A fourth scenario involves the operating system deallocating a virtual page, such as in response to termination of a task, and subsequently reallocating the virtual page, such as to a new task. When the operating system deallocates the virtual page, it marks the page table entry for the virtual page invalid and correspondingly invalidates the entry in the TLB that is caching the now invalid page table entry. When the operating system subsequently reallocates the virtual page, the operating system may not necessarily want or easily be able to write the new mapping for the virtual page into the same TLB entry as the old mapping. Hence, when the operating system attempts to write the new mapping into the TLB, it will be attempting to write a duplicate matching entry.

A fifth scenario is simply that the operating system has a bug, or some other catastrophic error has occurred, in which a valid entry exists in the TLB and the operating system attempts to write a duplicate matching valid entry into the TLB.

To avoid creating a duplicate matching entry in the TLB, a solution is for the microprocessor to generate an exception to the operating system to notify the operating system of the condition. However, as may be understood from the descriptions above, the operating system need not necessarily be notified in the first four scenarios, since they are expected situations. Furthermore, the fact that the operating system will have to service more exceptions reduces the performance of the operating system, since it could otherwise be executing user programs rather than executing the exception handler. Still further, code must be added to the exception handling routine of the operating system to handle the expected situations in addition to truly exceptional conditions.

To address this problem, the present invention provides an indicator, referred to as the Include (Inc) bit, in each entry of the TLB that specifies whether to include or exclude the entry in virtual page address match determinations. If a TLB write attempts to cause a duplicate matching entry, then the Inc bit is cleared for the matching entry. If the situation is an unexpected situation, such as when a valid matching entry exists in the TLB and the value being written is also valid, then the write is aborted and an exception is generated. Otherwise, if the situation is an expected one, then no exception is generated and the cleared Inc bit causes the matching entries to be excluded thereby preventing duplicate matching entries from being found in subsequent TLB lookup operations.

The scenarios described above are given as examples in which software may attempt to write duplicate entries into a TLB for the purpose of aiding in understanding the present invention and its advantages. However, the list of example scenarios is not intended to be an exhaustive list of situations in which software may attempt to write duplicate entries into a TLB, nor is it an attempt to list all the problems solved by the present invention. It should be understood that other situations in which software may attempt to write duplicate entries into a TLB may exist and the present invention may solve other problems not described herein.

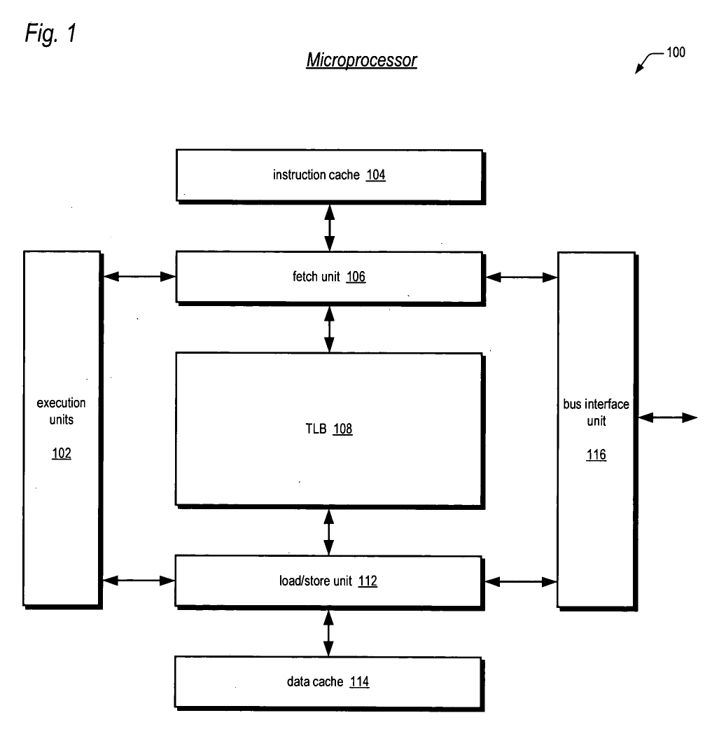

Referring now to FIG. 1, a block diagram of a microprocessor core 100 according to the present invention is shown. In one embodiment, microprocessor core 100 conforms substantially to a processor core available from MIPS Technologies, Inc. However, the present invention is not limited to MIPS microprocessor cores, but may be used in other microprocessors having user-programmable TLBs.

Microprocessor 100 includes a fetch unit 106 that fetches program instructions for execution by microprocessor 100. Fetch unit 106 is coupled to an instruction cache 104 that caches instructions recently fetched into microprocessor 100. In one embodiment, instruction cache 104 comprises a 4-way set associative 64 KB cache. Fetch unit 106 is also coupled to a bus interface unit 116, which interfaces microprocessor 100 to other portions of a computer system, such as a system memory, via a processor bus. Fetch unit 106 determines whether a next instruction to be fetched is present in instruction cache 104. If so, fetch unit 106 fetches the instruction from instruction cache 104; otherwise, fetch unit 106 requests bus interface unit 116 to fetch the instruction from the system memory or another cache in the memory hierarchy between the instruction cache 104 and the system memory. In one embodiment, fetch unit 106 includes control logic for instruction cache 104, an instruction buffer, an instruction decoder, and a branch instruction predictor.

Microprocessor 100 also includes execution units 102 coupled to fetch unit 106. Execution units 102 execute program instructions fetched by fetch unit 106. In one embodiment, execution units 102 comprise an address generation unit, a branch resolution unit, an ALU for performing logical operations, a shifter and aligner, an integer multiply/divide unit, and a floating point unit. Fetch unit 106 issues instructions to the execution units 102.

Microprocessor 100 also includes a load/store unit 112 coupled to bus interface unit 116 and to the execution units 102. Load/store unit 112 performs loads of data from system memory into registers of microprocessor 100 in execution units 102 via bus interface unit 116 and performs stores of data from the registers to system memory. Load/store unit 112 is also coupled to a data cache 114 that caches data recently used by microprocessor 100. In one embodiment, data cache 114 comprises a 4-way set associative 64 KB cache. If load or store data is cacheable, load/store unit 112 determines whether the cache line implicated by the load or store data is present in data cache 114. If so, load/store unit 112 loads the data from data cache 114 or stores the data to data cache 114; otherwise, load/store unit 112 requests bus interface unit 116 to read the data from or store the data to the system memory. In one embodiment, load/store unit 112 performs write allocation on store data that misses in data cache 114.

Microprocessor 100 also includes a translation lookaside buffer (TLB) 108 coupled to fetch unit 106 and load/store unit 112. TLB 108 comprises a cache of page translation entries used to translate virtual memory addresses into physical memory addresses. TLB 108 translates virtual memory addresses generated by fetch unit 106 and load/store unit 112 into physical memory addresses. In particular, TLB 108 translates virtual addresses to physical addresses used to determine whether an instruction request hits in instruction cache 104 or a data request hits in data cache 114. In one embodiment, TLB 108 is programmed by the operating system or similar system software running on microprocessor 100.

In one embodiment, TLB 108 comprises an instruction micro-TLB for servicing instruction cache 104, a data micro-TLB for servicing data cache 114, and a joint TLB that backs the two micro-TLBs. The micro-TLBs contain subsets of the joint TLB. In one embodiment, the joint TLB comprises a configurable 16/32/64 dual-entry fully associative joint TLB, the instruction micro-TLB comprises a 4-entry fully associative TLB, and the data micro-TLB comprises an 8-entry fully associative TLB. In one embodiment, when software programs TLB 108, the information written into TLB 108 is written into the joint TLB, and the micro-TLBs are not software visible. When a TLB lookup is performed to translate a virtual address to a physical address, the micro-TLBs are accessed first. If there is no matching entry in the micro-TLB, the joint TLB is used to translate the virtual address to a physical address and to refill the micro-TLB. If there is no matching entry in the joint TLB, a TLB refill exception is generated. TLB 108 will now be described in detail with respect to the remaining Figures.

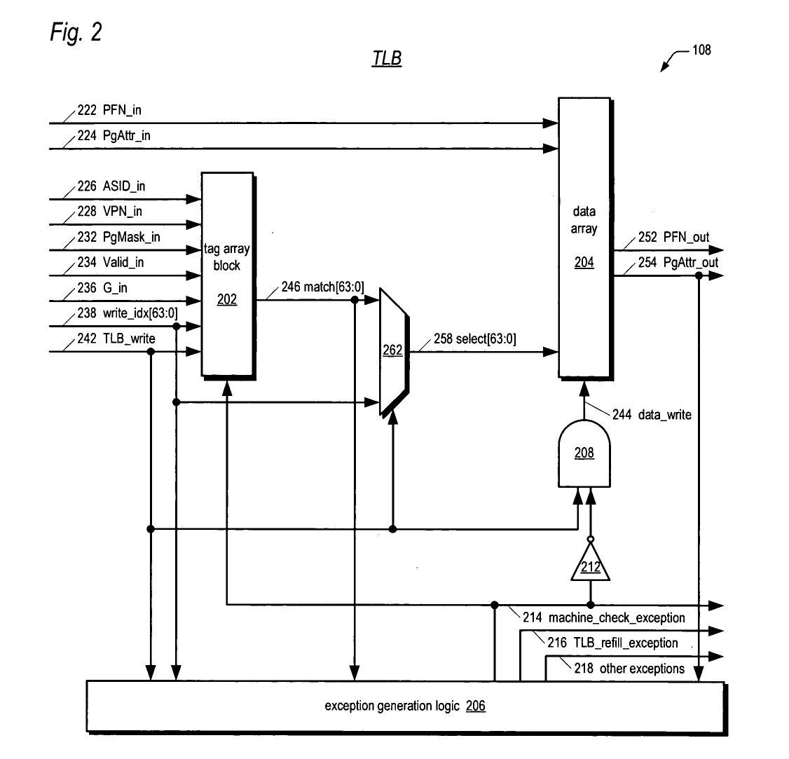

Referring now to FIG. 2, a block diagram of the TLB 108 of FIG. 1 according to the present invention is shown. TLB 108 receives requests to perform a lookup operation to determine whether a virtual address tag matches the tag of an entry present in TLB 108. In one embodiment, the lookup virtual address tag is specified on a VPN_in input 228 and an ASID_in input 226.

The VPN_in input 228, specifies the virtual page address of a memory page, also referred to as a virtual page number (VPN). If a tag match occurs, TLB 108 outputs the translated physical page address, also referred to as a physical frame number (PFN), translated from the virtual page address 228 on a PFN_out output 252 and outputs the page attributes of the page on a PgAttr_out output 254. In one embodiment, VPN_in 228 comprises 20 bits.

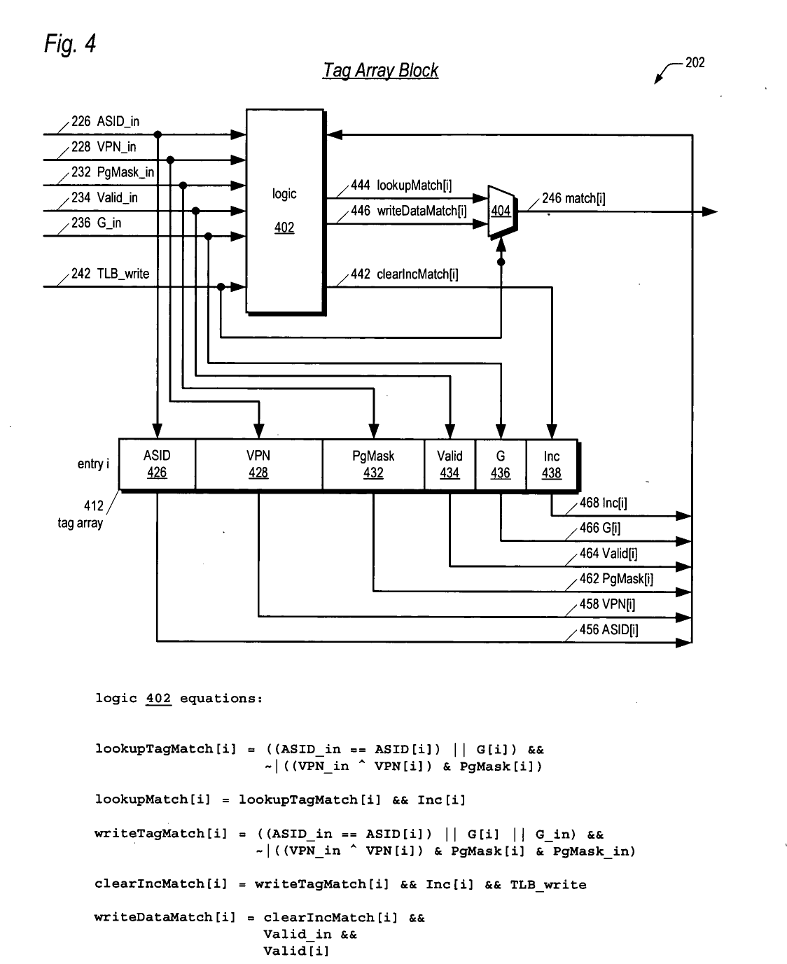

The ASID_in input 226 specifies an address space identifier (ASID) that identifies an address space. In one embodiment, an operating system running on microprocessor 100 allocates an address space to each active process, or task, running on microprocessor 100 and assigns an ASID to the address space. Hence, the VPN_in 228 is implicitly extended by the ASID_in 226 to produce a unique virtual address tag to be looked up by TLB 108. In one embodiment, ASID_in 226 comprises 8 bits for specifying 256 unique address spaces. As described with respect to the equations shown in FIG. 4, the ASID_in 226 is selectively included along with the VPN_in 228 in the tag match determination depending upon the value of a G bit 436 stored in each TLB 108 entry, which is described below.

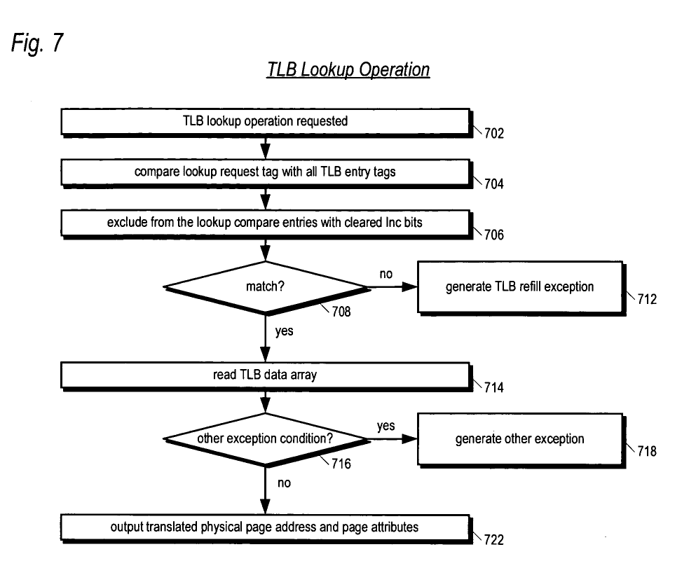

If the lookup operation does not yield a tag match, then TLB 108 generates a TLB_refill_exception 216 to enable the operating system to refill, i.e., to write, the TLB 108 with an entry specifying the translation of the lookup virtual address tag that missed in the TLB 108. The TLB 108 lookup operation is described in detail with respect to the remaining Figures and particularly with respect to FIG. 7.

Additionally, TLB 108 receives requests to write an entry in TLB 108 with values specified by a plurality of inputs 222 through 236. TLB 108 also receives a write_idx input 238 that specifies which entry in TLB 108 is to be written. TLB 108 receives a TLB_write input 242 that indicates whether the request is for writing an entry into TLB 108. The TLB 108 write request entry includes a tag portion, a valid bit, and a data portion. The tag values are stored into a tag array block 202 and the data values are stored into a data array 204.

The TLB 108 write request data comprises a PFN_in input 222 and a PgAttr_in input 224. The PFN_in input 222 specifies a physical frame number (PFN), or physical page address, to be written into data array 204. The PgAttr_in input 224 specifies attributes of the memory page specified by the PFN_in input 222 to be written into data array 204. In one embodiment, the page attributes specified by PgAttr_in input 224 comprise a valid bit, a write-enable bit, a dirty bit for indicating whether the page has been written, and cache coherency attributes.

The TLB 108 write request tag comprises a virtual page address provided on VPN_in input 228 and an ASID provided on ASID_in input 226.

The TLB 108 write request tag also comprises a PgMask_in input 232. In one embodiment, microprocessor 100 supports variable page sizes. The PgMask_in input 232 specifies a page mask value used to determine the size of the page specified by the virtual address 228. When a TLB 108 write request is received, the PgMask_in value 232 is used as a qualifier to determine whether a tag match has occurred, as described with respect to the equations shown in FIG. 4.

The TLB 108 write request tag also comprises a global (G) bit input G_in 236 that indicates whether the ASID_in 226 should be included when determining whether a tag match has occurred. In one embodiment, if G_in 236 is set, then the ASID_in 226 is excluded from the tag match determination, as described in the equations of FIG. 4. In one embodiment, G_in 236 enables the operating system to implement a portion of the virtual address space that is shared among all processes.

The TLB 108 write request also comprises a Valid bit input Valid_in 234 that indicates whether the entry being written into TLB 108 is valid. Valid_in 234 enables an entry in the TLB 108 to be programmed with a valid virtual to physical address translation or to be invalidated. In particular, Valid_in 234 enables the operating system to invalidate an entry in the TLB 108.

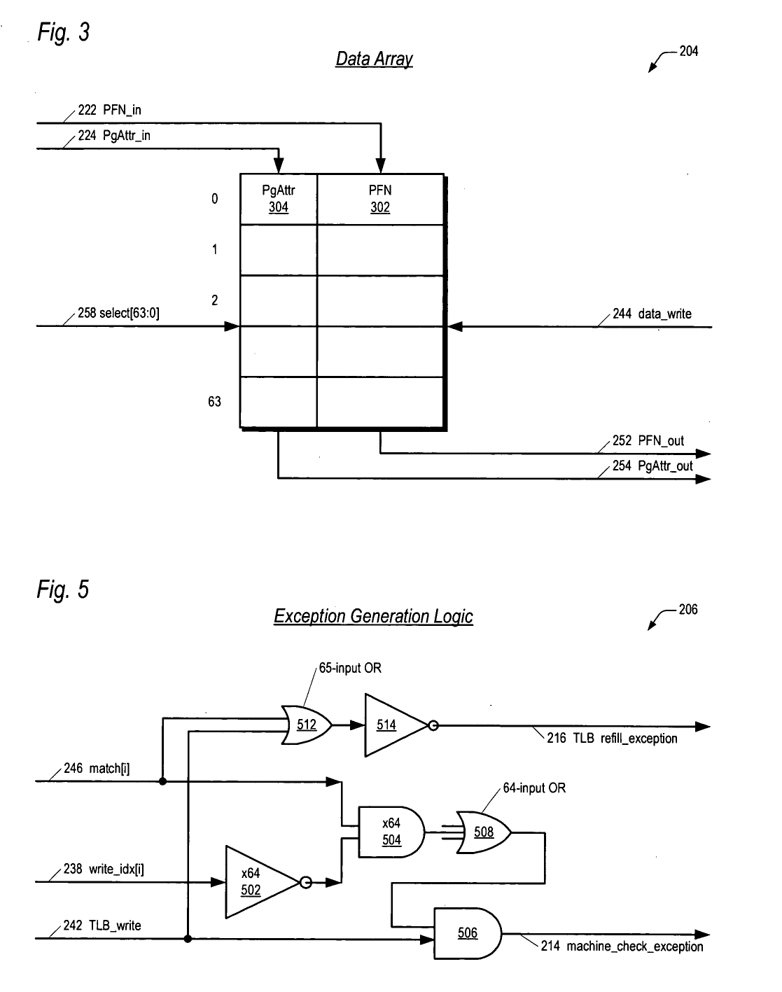

TLB 108 also includes a data array 204. Data array 204 comprises an array of storage elements, each for storing a portion of a TLB 108 entry, as shown in FIG. 3.

Referring now to FIG. 3, a block diagram of the data array 204 of FIG. 2 according to the present invention is shown. In the embodiment of FIG. 3, data array 204 includes 64 entries. However, the present invention is not limited to a TLB with a particular number of entries, but may be employed in a TLB of various sizes. Each entry in data array 204 includes a physical frame number (PFN) 302, also referred to as a physical page address 302, and page attributes (PgAttr) 304 of the memory page specified by the corresponding PFN 302. Data array 204 receives PFN_in input 222 and PgAttr_in input 224. Data array 204 also receives a select input 258 and a data_write input 244. If the data_write input 244 indicates data array 204 is to be written, then the PFN 302 of the entry specified by the select input 258 is written with the value on the PFN_in input 222 and the PgAttr 304 is written with the value on the PgAttr_in input 224. Conversely, if data array 204 is being read, then data array 204 outputs the PFN 302 of the entry specified by the select input 258 on PFN_out 252 and the PgAttr 304 on PgAttr_out 254.

Referring now to FIG. 4, a block diagram of tag array block 202 of FIG. 2 according to the present invention is shown. Tag array block 202 comprises a tag array 412 of storage elements each for storing a portion of a TLB 108 entry. FIG. 4 shows the contents of a single representative entry in tag array 412, referred to as entry i, and other elements associated with each tag array block 202 entry. Although FIG. 4 shows storage elements and logic for a single tag array entry, it is understood that tag array 412 comprises a plurality of entries. In one embodiment, tag array 412 comprises 64 entries corresponding to the 64 entries of the data array 204 of the embodiment of FIG. 3. Although the TLB 108 has been described with a particular number of entries, it should be understood that the invention is not limited to a particular number of TLB entries.

A tag array 412 entry includes a virtual page number (VPN) 428, also referred to as a virtual page address 428, that stores the virtual address of a memory page whose translated physical page address 302 is stored in a corresponding entry of data array 204 of FIG. 3. In one embodiment, VPN 428 comprises 20 bits. As described in the equations of FIG. 4, the value of VPN 428 is used to determine whether a tag match has occurred. In the case of a TLB 108 write, the value of VPN_in input 228 is written into VPN 428.

A tag array 412 entry also includes an ASID field 426 specifying the address space identifier of the tag array 412 entry. As described in the equations of FIG. 4, the ASID field 426 is selectively used to determine whether a tag match has occurred based on the value of the G bit 436 in the case of a TLB 108 lookup, and on the value of the G bit 436 and G_in input 236 in the case of a TLB 108 write. In one embodiment, ASID 426 comprises 8 bits for specifying 256 unique address spaces. In the case of a TLB 108 write, the value of ASID_in input 226 is written into ASID field 426.

A tag array 412 entry also includes a page mask (PgMask) field 432 that stores a mask value used to determine the size of the page specified by the TLB 108 entry. As described in the equations of FIG. 4, the PgMask field 432 is used as a qualifier to determine whether a tag match has occurred. In the case of a TLB 108 write, the value of PgMask_in input 232 is written into PgMask field 432.

A tag array 412 entry also includes a global (G) bit 436 that indicates whether the ASID 426 should be included or excluded in a tag match determination. As described in the equations of FIG. 4, in one embodiment, if G bit 436 is set, then the ASID field 426 is excluded from the tag match determination. In one embodiment, G bit 436 enables the operating system to implement a portion of the virtual address space that is shared among all processes. In the case of a TLB 108 write, the value of G_in input 236 is written into G bit 436.

A tag array 412 entry also includes a Valid bit 434 that indicates whether the TLB 108 entry is valid. That is, Valid bit 434 specifies whether the physical page address 302 and page attributes 304 stored in the corresponding entry of data array 204 are a valid translation of the virtual address tag specified by the ASID 426, VPN 428, PgMask 432, and G 436 fields in the corresponding TLB 108 entry.

A tag array 412 entry also includes an Include (Inc) bit 438. Inc bit 438 specifies whether the tag array 412 entry is to be included in a tag match determination. In one embodiment, if Inc bit 438 is set, the TLB 108 entry is included in the tag match determination; conversely, if Inc bit 438 is clear, the TLB 108 entry is excluded from the tag match determination. Although Inc bit 438 has been described with a set value meaning the TLB 108 entry is to be included in the tag match determination and a cleared value meaning the TLB 108 entry is to be excluded from the tag match determination, it should be understood that the opposite polarity could be employed and the present invention is not limited to either convention. Furthermore, it should be understood that Inc bit 438 may be incorporated or encoded into other control fields in TLB 108 and is not limited to being a single or separate bit.

Inc bit 438 is cleared in response to a reset of TLB 108. Inc bit 438 is also cleared by a true value on a clearIncMatch signal 442, as described below. In one embodiment, the Inc bit 438 is not user-visible. Rather, the Inc bit 438 is hidden from the user and is set and cleared by the tag array block 202, as described below. Advantageously, Inc bit 438 facilitates prevention of duplicate matching entries in TLB 108, and is used to do so in a manner that reduces the number of exceptions generated by microprocessor 100.

Tag array block 202 also includes logic 402 coupled to the tag array 412 entry for each entry of tag array 412. Logic 402 receives the ASID_in 226, VPN_in 228, PgMask_in 232, Valid_in 234, G_in 236, and TLB_write 242 inputs. Logic 402 also receives as inputs the outputs of tag array 412 storage element fields 426, 428, 432, 434, 436, and 438, denoted in FIG. 4 as ASID 456, VPN 458, PgMask 462, Valid 464, G 466, and Inc 468, respectively. In response to its inputs, logic 402 generates a lookupMatch output 444, a writeDataMatch output 446, and clearIncMatch output 442, according to the equations shown in FIG. 4.

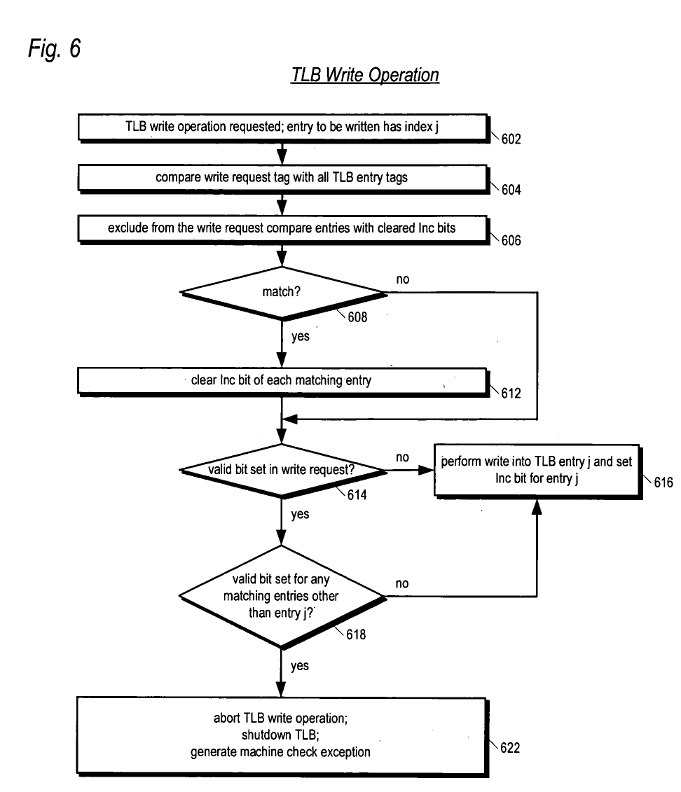

Tag array block 202 also includes for each entry of tag array 412 a multiplexer 404 coupled to logic 402. Multiplexer 404 receives on one of its data inputs lookupMatch output 444 from logic 402. Multiplexer 404 receives on its other data input writeDataMatch output 446 from logic 402. Multiplexer 404 receives TLB_write input 242 as its select input. If TLB_write input 242 is true, then multiplexer 404 provides the writeDataMatch input 446 value on its output, denoted match 246; otherwise, multiplexer 404 provides the lookupMatch input 444 value on match 246. WriteDataMatch 446 is used to determine whether a machine check exception should be generated, as described below, particularly with respect to FIGS. 5 and 6. During a TLB 108 lookup operation, lookupMatch 444 eventually becomes select 258 and is used to select the appropriate data array 204 entry to output on PFN_out 252 and PgAttr_out 254.

In one embodiment, multiplexer 404 is collapsed into logic 402 by using TLB_write 242 to force PgMask_in 232 to 1 and G_in 236 to 0 on a TLB 108 lookup and to use Valid 434 and Valid_in 234 as qualifiers on a TLB 108 write to generate match 246.

Referring again to FIG. 2, TLB 108 also includes a multiplexer 262 coupled to tag array block 202. Multiplexer 262 receives on one of its data inputs match output 246 of tag array block 202. Multiplexer 262 receives on its other data input write_idx 238. Multiplexer 262 receives TLB_write input 242 as its select input. If TLB_write input 242 is true, then multiplexer 262 provides the write_idx 238 value on its output, denoted select 258; otherwise, multiplexer 262 provides the match 246 value on select 258.

TLB 108 also includes a two-input AND gate 208 and an inverter 212 coupled to data array 204. Inverter 212 receives machine_check_exception output 214 on its input and provides its output to one input of AND gate 208. AND gate 208 receives TLB_write signal 242 on its other input. AND gate 208 generates data_write 244 output that is provided as an input to data array 204. Thus, the entry of data array 204 specified by select signal 258 is written when TLB_write 242 indicates a TLB write operation is requested and when the write request does not cause a machine check exception.

TLB 108 also includes exception generation logic 206 coupled to tag array block 202. Exception generation logic 206 receives TLB_write 242, write_idx 238, match 246, and PgAttr_out 254. Exception generation logic 206 generates machine_check_exception 214 in response to its inputs as described with respect to FIGS. 5 and 6. Exception generation logic 206 also generates a TLB_refill_exception output 216 in response to its inputs as described with respect to FIGS. 5 and 7. Exception generation logic 206 also generates other exceptions on output 218 in response to its inputs as described with respect to FIG. 7.

In one embodiment, TLB 108 employs dual-page entries. That is, data array 204 includes two entries for each tag array 412 entry. Each tag array 412 entry stores a virtual address tag that specifies two virtually adjacent memory pages that can be mapped by the operating system to physically non-adjacent memory pages.

Referring now to FIG. 5, a block diagram illustrating the exception generation logic 206 of FIG. 2 according to the present invention is shown. The embodiment of exception generation logic 206 of FIG. 5 is for a 64 entry TLB 108. Exception generation logic 206 includes an inverter 502 and a two-input AND gate 504 associated with each TLB 108 entry. Each inverter 502 receives write_idx 238 of FIG. 2 for the corresponding TLB 108 entry and provides its output to one input of corresponding AND gate 504. AND gate 504 receives on its other input match 246 of FIG. 2 for the corresponding TLB 108 entry. Inverters 502 and AND gates 504 function to exclude the entry specified by a TLB 108 write request from the machine_check_exception 214 generation.

Exception generation logic 206 also includes a 64-input OR gate 508 that receives the output of each of the 64 AND gates 504. Exception generation logic 206 also includes a two-input AND gate 506. AND gate 506 receives on one input the output of OR gate 508. AND gate 506 receives on its other input TLB_write 242. AND gate 506 generates machine_check_exception 214 on its output.

Exception generation logic 206 also includes a 65-input OR gate 512 that receives all 64 match signals 246 and TLB_write 242. Exception generation logic 206 also includes an inverter 514 that receives the output of OR gate 512 and generates as its output TLB_refill_exception 216.

Referring now to FIG. 6, a flowchart illustrating operation of the microprocessor 100 during a write operation to the TLB 108 of FIG. 1 according to the present invention is shown. Flow begins at block 602.

At block 602, TLB 108 receives a write operation request. The write operation request specifies the index of the entry of TLB 108 to be written. In FIG. 6, the index to be written is specified as “j”. The write request also specifies the values to be written into the TLB 108 entry at index j. The values to be written are provided to TLB 108 on input signals 222 through 236 of FIG. 2. In one embodiment, microprocessor 100 generates a write request to TLB 108 in response to execution of a TLBWI or TLBWR instruction, which instruct microprocessor 100 to write an entry of TLB 108 with values specified in software-visible registers of microprocessor 100. The index of the TLB 108 entry to be written is specified explicitly by the TLBWI instruction. However, with regard to a TLBWR instruction, the index of the TLB 108 entry to be written is specified by a Random register of microprocessor 100. In one embodiment, Random register decrements substantially each clock cycle of microprocessor 100, wrapping to a maximum once its value is equal to a value in a Wired register, which is user-programmable. In one embodiment, microprocessor 100 does not provide information regarding which TLB 108 entry is most desirable to be replaced, such as which entry is least-recently-used. Hence, the TLBWR instruction provides a method for replacing TLB 108 entries when a lookup tag misses in TLB 108. The index of the TLB 108 entry to be written is decoded and provided on write_idx 238. Flow proceeds to block 604.

At block 604, logic 402 of FIG. 4 compares the write request tag with each tag in tag array 412, according to the writeTagMatch equation of FIG. 4. Flow proceeds to block 606.

At block 606, logic 402 excludes TLB 108 entries having a clear Inc bit 438, according to the clearIncMatch 442 for each TLB 108 entry and writeDataMatch 446 equations of FIG. 4. Flow proceeds to decision block 608.

At decision block 608, TLB 108 determines whether a tag match has occurred by examining clearIncMatch 442 to see if it has a true value. If so, then flow proceeds to block 612; otherwise, flow proceeds to decision block 614.

At block 612, Inc bit 438 is cleared for each TLB 108 entry having a true value on clearIncMatch 442. Flow proceeds to decision block 614.

At decision block 614, TLB 108 determines whether Valid_in 234 is true, according to the writeDataMatch equation of FIG. 4. If not, flow proceeds to block 616; otherwise, flow proceeds to decision block 618.

At block 616, TLB 108 writes into TLB 108 entry j the values specified by inputs 222 through 236 and sets Inc bit 438 for entry j. Flow ends at block 616.

At decision block 618, TLB 108 determines whether Valid 434 is true for any TLB 108 entries, other than entry j, having a matching tag whose Inc bit 438 is set, according to the writeDataMatch equation of FIG. 4 and machine_check_exception 214 generation logic 502 through 508 of FIG. 5. If not, flow proceeds to block 616; otherwise, flow proceeds to block 622.

At block 622, TLB 108 aborts the write operation, shuts down TLB 108, and generates a machine_check_exception 214. The machine_check_exception 214 is generated according to the machine_check_exception 214 generation logic 502 through 508 of FIG. 5. The write operation is aborted by operation of data_write 244 generation logic 208 and 212 outputting a false value on data_write 244. Flow ends at block 622.

Referring now to FIG. 7, a flowchart illustrating operation of the microprocessor 100 during a lookup operation of the TLB 108 of FIG. 1 according to the present invention is shown. Flow begins at block 702.

At block 702, TLB 108 receives a lookup operation request. In a typical case, fetch unit 106 or load/store unit 112 of FIG. 1 issues a lookup request to TLB 108 in order to obtain the physical page address of an instruction or data to be read from or written to instruction cache 104, data cache 114, or system memory via bus interface unit 116. The lookup operation request specifies a VPN and ASID of the lookup tag via VPN_in 228 and ASID_in 226. The lookup operation request requests TLB 108 to determine whether the specified lookup tag matches any of the TLB 108 entry tags, and if so, to output the PFN 302 and PgAttr 304 of the matching entry. That is, the lookup operation request requests TLB 108 to translate the virtual address specified on VPN_in 228 and ASID_in 226. Flow proceeds to block 704.

At block 704, logic 402 of FIG. 4 compares the lookup request tag with each tag in tag array 412, according to the lookupTagMatch equation of FIG. 4. Flow proceeds to block 706.

At block 706, logic 402 excludes TLB 108 entries having a clear Inc bit 438, according to the lookupMatch 444 equation of FIG. 4. Flow proceeds to decision block 708.

At decision block 708, TLB 108 determines whether a tag match has occurred by examining lookupMatch 444 to see if it has a true value. If not, then flow proceeds to block 712; otherwise, flow proceeds to block 714.

At block 712, exception generation logic 206 generates a TLB_refill_exception 216 since lookupMatch 444 indicates to exception generation logic 206 via match 246 that the lookup tag did not match any TLB 108 entries. In one embodiment, if microprocessor 100 is already processing an exception, then exception generation logic 206 generates a TLB Invalid Exception on output 218 rather than a TLB_refill_exception 216. Flow ends at block 712.

At block 714, select 258 is provided to data array 204 in order to read the matching entry of data array 204. Flow proceeds to decision block 716.

At decision block 716, TLB 108 determines whether any other exception condition has occurred. In one embodiment, exception generation logic 206 examines the page attributes provided on PgAttr_in 224 to determine whether another exception condition has occurred. In one embodiment, exception generation logic 206 determines that a TLB Invalid Exception condition has occurred if a TLB 108 entry tag matches the lookup tag, but the matching entry is invalid. In one embodiment, exception generation logic 206 determines that a TLB Modified Exception condition has occurred if a TLB 108 entry tag matches the lookup tag and the entry is valid but not dirty. If another exception condition has occurred, flow proceeds to block 718; otherwise, flow proceeds to block 722.

At block 718, exception generation logic 206 generates a true value on output 218. Flow ends at block 718.

At block 722, data array 204 outputs the PFN 302 and PgAttr 304 of the data array 204 entry selected by select 258 on PFN_out 252 and PgAttr_out 254, respectively. Flow ends at block 722.

In one embodiment, microprocessor 100 also includes a TLBP instruction, which instructs microprocessor 100 to probe TLB 108 for an entry that matches the lookup tag. However, in contrast to a normal lookup operation, the TLBP instruction simply returns the index of the entry in TLB 108 containing the matching tag. The operation of the TLBP instruction operates similar to the lookup operation described in FIG. 7. However, the translated physical address is not output at block 722, but instead the index of the matching entry is stored into a software-visible register. Additionally, if no match is found at block 708, a TLB refill exception is not generated, but instead a status bit is set in a software-visible status register to indicate that no match was found.

In one embodiment, microprocessor 100 also includes a TLBR instruction, which instructs microprocessor 100 to read an entry of TLB 108 specified by an index value specified in the TLBR instruction. Hence, in contrast to a normal lookup operation, the TLBR instruction does not specify an input tag, but instead supplies the index of the TLB 108 entry to be read.

As may be observed from the foregoing, the apparatus and method described herein prevents duplicate matching entries in TLB 108 and advantageously reduces the number of exceptions generated in response to attempts to write a duplicate matching entry in a TLB. Reducing the number of exceptions generated produces at least two possible advantages. First, the exception handler code may be simplified since expected situations such as those described above should no longer occur. Second, the performance of the software executing on the processor with the TLB is potentially increased since the operating system has to field fewer exceptions when a TLB write is performed that would have caused an exception without the present invention.

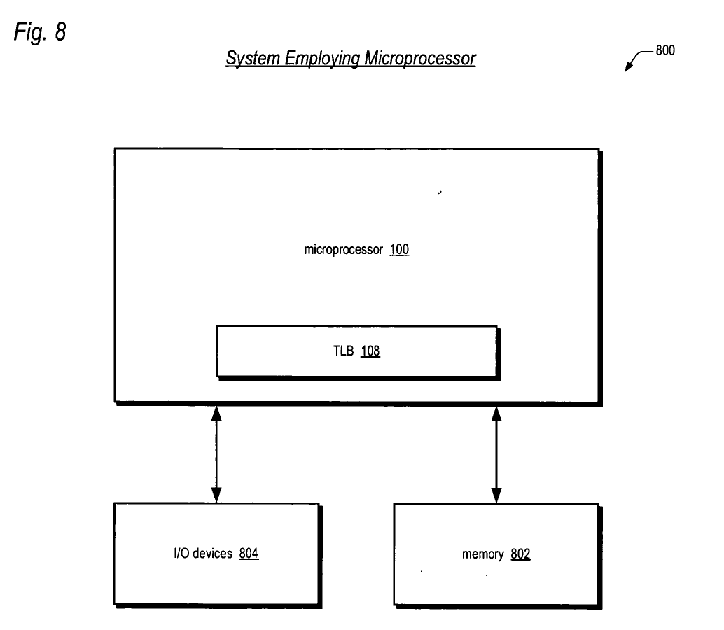

Referring now to FIG. 8, a block diagram of a system 800 for processing a stored program according to the present invention is shown. The system 800 includes the microprocessor 100 of FIG. 1 coupled to a memory 802 and one or more input/output (I/O) devices 804. The microprocessor 100 includes the translation lookaside buffer 108 of FIG. 1. The system 800 may include a computer system, including but not limited to a personal computer, workstation computer, server computer, notebook computer, personal digital assistant, file server, print server, enterprise server, and the like. The system 800 may also include an embedded system, including but not limited to a set-top box, intelligent peripheral device, automobile embedded system, embedded system in an appliance, mass storage controller, and the like.

The memory 802 comprises a memory for storing program instructions and data to be processed by the microprocessor 100. The memory 802 may comprise any memory suitable for storing program instructions and data, including but not limited to, dynamic random access memory (DRAM), static random access memory (SRAM), synchronous DRAM (SDRAM), double-data rate SDRAM (DDR-SDRAM), Rambus DRAM (RDRAM), read-only memory (ROM), programmable read-only memory (PROM), erasable PROM (EPROM), electrically erasable PROM (EEPROM), FLASH memory, and the like, or any combination thereof.

The I/O devices 804 comprise devices for receiving data as input for provision to the microprocessor 100 for processing, including but not limited to user input. The I/O devices 804 also comprise devices for receiving from the microprocessor 100 results of the processing and for outputting the results, including but not limited to user output. The I/O devices 804 may include, but are not limited to direct memory access controllers, timers, clocks, interrupt controllers, serial port controllers, parallel port controllers, USB port controllers, IEEE 1394 controllers, SCSI controllers, ATA controllers, Fibre Channel controllers, floppy disk controllers, hard disk controllers, graphics controllers, display devices, keyboards, mice, scanners, plotters, printers, floppy disk drives, hard disk drives, optical storage devices, tape drives, digital cameras, and the like, or any combination thereof.

Although the present invention and its objects, features, and advantages have been described in detail, other embodiments are encompassed by the invention. For example, although the Include bit is described with a set value meaning the entry is to be included in the match results and a clear value meaning the entry is not to be included, the invention may be modified to use the opposite convention. Similarly, although the Include bit has been described as a single bit, all which is required is an indicator of whether to include the entry in the match results; hence, the indicator could be more than one bit and could be encoded with other indicator fields. Furthermore, although the invention has been described with respect to an operating system running on the microprocessor, the invention is applicable to any software executing on the microprocessor, such as embedded system software or firmware.

Although the present invention and its objects, features and advantages have been described in detail, other embodiments are encompassed by the invention. In addition to implementations of the invention using hardware, the invention can be embodied in software (e.g., computer readable code, program code, instructions and/or data) disposed, for example, in a computer usable (e.g., readable) medium. Such software enables the function, fabrication, modeling, simulation, description and/or testing of the apparatus and method described herein. For example, this can be accomplished through the use of general programming languages (e.g., C, C++, JAVA, etc.), GDSII databases, hardware description languages (HDL) including Verilog HDL, VHDL, and so on, or other available programs, databases, and/or circuit (i.e., schematic) capture tools. Such software can be disposed in any known computer usable (e.g., readable) medium including semiconductor memory, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. It is understood that the invention can be embodied in software (e.g., in HDL as part of a semiconductor intellectual property core, such as a microprocessor core, or as a system-level design, such as a System on Chip or SOC) and transformed to hardware as part of the production of integrated circuits. Also, the invention may be embodied as a combination of hardware and software.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

1. A method for preventing duplicate matching entries in a translation lookaside buffer (TLB), the method comprising:
receiving a request to write an entry of the TLB, wherein the write request includes a tag;
determining which entries of the TLB have a tag matching the write request tag; and
clearing an indicator in each entry of the TLB entries having a tag matching the write request tag.

2. The method of claim 1, further comprising:
determining whether the write request is valid;
determining whether any of the matching TLB entries other than the entry specified by the write request is valid;
excluding each matching TLB entry whose indicator is clear; and
generating an exception, if the write request is valid and one or more of the non-excluded matching TLB entries other than the entry specified by the write request is valid.

3. The method of claim 2, wherein the exception indicates the write request is attempting to write a duplicate matching entry in the TLB.

4. The method of claim 2, wherein said generating the exception is performed only if the write request is valid and one or more of the non-excluded matching TLB entries other than the entry specified by the write request is valid.

5. The method of claim 2, wherein said generating the exception is not performed if the write request is invalid.

6. The method of claim 2, wherein said generating the exception is not performed if each of the non-excluded matching TLB entries other than the entry specified by the write request is invalid.

7. The method of claim 2, wherein said determining whether the write request is valid comprises determining whether a valid bit included in the write request is true.

8. The method of claim 7, wherein the valid bit is user-programmable.

9. The method of claim 2, wherein said determining whether any of the matching TLB entries other than the entry specified by the write request is valid comprises determining whether a valid bit included in the matching TLB entries other than the entry specified by the write request is true.

10. The method of claim 9, wherein the valid bit is user-programmable.

11. The method of claim 2, wherein the exception comprises a machine check exception.

12. The method of claim 2, further comprising:
aborting the write operation, if the write request is valid and one or more of the non-excluded matching TLB entries other than the entry specified by the write request is valid.

13. The method of claim 2, further comprising:
disabling operation of the TLB, if the write request is valid and one or more of the non-excluded matching TLB entries other than the entry specified by the write request is valid.

14. The method of claim 1, further comprising:
writing the TLB entry specified by the write request, if the write request is invalid.

15. The method of claim 1, further comprising:
setting the indicator in the TLB entry specified by the write request, if the write request is invalid.

16. The method of claim 1, further comprising:
writing the entry specified by the write request, if each of the non-excluded matching TLB entries other than the entry specified by the write request is invalid.

17. The method of claim 1, further comprising:
setting the indicator in the entry specified by the write request, if each of the non-excluded matching TLB entries other than the entry specified by the write request is invalid.

18. The method of claim 1, further comprising:
receiving a request to lookup an entry in the TLB having a tag matching a tag specified by the lookup request, after said clearing the indicator in each entry of the TLB having a tag that matches the write request tag; and
excluding from the lookup each entry in the TLB having its indicator cleared.

19. The method of claim 18, further comprising:
including in the lookup each entry in the TLB having the indicator set.

20. The method of claim 1, wherein the tag comprises a virtual page address.

21. The method of claim 20, wherein the tag comprises an address space identifier.

22. The method of claim 21, wherein the tag comprises a control value for selectively specifying exclusion of the address space identifier in said determining which entries of the TLB have a tag matching the write request tag.

23. The method of claim 20, wherein the tag comprises a mask field for specifying a portion of the virtual page address to exclude in said determining which entries of the TLB have a tag matching the write request tag.

24. The method of claim 1, further comprising:
receiving a request to reset the TLB; and
clearing the indicator in each entry of the TLB, in response to said receiving the reset request.

25. The method of claim 1, wherein the request to write the TLB comprises an instruction executed by a microprocessor comprising the TLB.

26. The method of claim 25, wherein the instruction instructs the microprocessor to select the TLB entry specified by the write request at random.

27. A method for preventing duplicate matching entries in a translation lookaside buffer (TLB), the method comprising:
receiving a request to lookup a tag in the TLB; and
excluding from the lookup each entry of the TLB having an indicator with a cleared value.

28. The method of claim 27, wherein for each TLB entry the indicator is cleared when a write request is received by the TLB that has a tag matching the TLB entry tag.

29. The method of claim 28, wherein for each TLB entry the indicator is set if the TLB entry is actually written in response to the write request.

30. The method of claim 29, wherein the TLB aborts the write request if the write request is valid and one or more entries of the TLB having its indicator set and having a tag matching the write request tag, other than the TLB entry specified by the write request, is valid.

31. The method of claim 29, wherein the TLB generates an exception if the write request is valid and one or more entries of the TLB having its indicator set and having a tag matching the write request tag, other than the TLB entry specified by the write request, is valid.

32. The method of claim 27, wherein said indicator is not user-accessible.

33. An apparatus for preventing duplicate matching entries in a translation lookaside buffer (TLB), the apparatus comprising:
a plurality of indicators, associated with a corresponding plurality of entries of the TLB, each for specifying whether to include said corresponding entry in a tag comparison operation; and
logic, coupled to said plurality of indicators, for clearing said corresponding indicator to a first predetermined value if said corresponding entry has a tag that matches a tag specified in a request to write one of said plurality of TLB entries.

34. The apparatus of claim 33, wherein said first predetermined value indicates said corresponding TLB entry is not to be included in said tag comparison operation.

35. The apparatus of claim 34, wherein said logic is further configured to set said corresponding indicator to a second predetermined value if the TLB actually writes to said corresponding TLB entry in response to said write request.

36. The apparatus of claim 35, wherein said second predetermined value indicates said corresponding TLB entry is to be included in said tag comparison operation.

37. The apparatus of claim 33, wherein said corresponding TLB entry tag comprises a virtual page address.

38. The apparatus of claim 37, wherein said tag comparison operation comprises comparing said virtual page address in said corresponding TLB entry with a virtual page address in said write request tag to determine whether said virtual addresses match.

39. The apparatus of claim 37, wherein said tag comparison operation comprises comparing said virtual page address in said corresponding TLB entry with a virtual page address in a lookup request tag to determine whether said virtual addresses match.

40. The apparatus of claim 33, further comprising:
an exception output, coupled to said plurality of indicators, for indicating a condition in which said write request is attempting to write a duplicate matching tag into said plurality of TLB entries.

41. The apparatus of claim 40, wherein the apparatus generates a true value on said exception output only if said write request is valid and at least one of said plurality of TLB entries other than said one of said plurality of TLB entries specified by said write request is valid, has its tag matching said tag of said write request, and does not have its indicator set to said first predetermined value.

42. The apparatus of claim 33, wherein the TLB actually writes said write request into said one of said plurality of TLB entries specified by said write request if said write request is invalid.

43. The apparatus of claim 33, wherein the TLB actually writes said write request into said one of said plurality of TLB entries specified by said write request if none of said plurality of TLB entries other than said one of said plurality of TLB entries specified by said write request is valid.

44. The apparatus of claim 33, wherein the TLB actually writes said write request into said one of said plurality of TLB entries specified by said write request if none of said plurality of TLB entries other than said one of said plurality of TLB entries specified by said write request has its tag matching said tag of said write request.

45. The apparatus of claim 33, wherein the TLB actually writes said write request into said one of said plurality of TLB entries specified by said write request if none of said plurality of TLB entries other than said one of said plurality of TLB entries specified by said write request has its indicator set to said first predetermined value.

46. The apparatus of claim 33, wherein each of said plurality of TLB entries comprises a physical page address mapped from said tag.

47. The apparatus of claim 46, wherein said tag of each of said plurality of TLB entries comprises a virtual page address, wherein said physical page address is mapped from said virtual page address.

48. The apparatus of claim 33, wherein said plurality of indicators are not software-visible.

49. The apparatus of claim 33, wherein a computer program product comprising a computer usable medium having computer read-able program code causes the apparatus, wherein said computer program product is for use with a computing device.

50. The apparatus of claim 33, wherein a computer data signal embodied in a transmission medium comprising computer-readable program code provides the apparatus.

51. A computer program product for use with a computing device, the computer program product comprising:
a computer usable medium, having computer readable program code embodied in said medium, for causing an apparatus for preventing duplicate matching entries in a translation lookaside buffer (TLB), said computer readable program code comprising:
first program code for providing a plurality of indicators, associated with a corresponding plurality of entries of the TLB, each for specifying whether to include said corresponding entry in a tag comparison operation; and
second program code for providing logic, coupled to said plurality of indicators, for clearing said corresponding indicator to a first predetermined value if said corresponding entry has a tag that matches a tag specified in a request to write one of said plurality of TLB entries.

52. A computer data signal embodied in a transmission medium, comprising:
computer-readable program code for providing an apparatus for preventing duplicate matching entries in a translation lookaside buffer (TLB), said program code comprising:
first program code for providing a plurality of indicators, associated with a corresponding plurality of entries of the TLB, each for specifying whether to include said corresponding entry in a tag comparison operation; and
second program code for providing logic, coupled to said plurality of indicators, for clearing said corresponding indicator to a first predetermined value if said corresponding entry has a tag that matches a tag specified in a request to write one of said plurality of TLB entries.

53. A processing system, comprising:
a memory, for storing program instructions; and
a microprocessor, coupled to said memory, for executing said program instructions, said microprocessor comprising an apparatus for preventing duplicate matching entries in a translation lookaside buffer (TLB) of said microprocessor, the apparatus comprising:
a plurality of indicators, associated with a corresponding plurality of entries of the TLB, each for specifying whether to include said corresponding entry in a tag comparison operation; and
logic, coupled to said plurality of indicators, for clearing said corresponding indicator to a first predetermined value if said corresponding entry has a tag that matches a tag specified in a request to write one of said plurality of TLB entries.

54. The processing system of claim 53, wherein said first predetermined value indicates said corresponding TLB entry is not to be included in said tag comparison operation.

55. The processing system of claim 53, further comprising:
at least one input/output (I/O) device, coupled to said microprocessor, configured to receive input data for provision to said microprocessor for processing, and to output results of said processing received from said microprocessor.
